(19) United States
(12) Patent Application Publication
(10) Pub. No.: US 2010/0295744 A1
(43) Pub. Date: Nov. 25, 2010

(54) Waveguide Array

(76) Inventors: Erik Lofbom, Marion, SC (US); Erik Geterud, Pixbo (SE)

Correspondence Address: DOWNS RACHLIN MARTIN PLLC, 199 MAIN STREET, P O BOX 190, BURLINGTON, VT, 05402-0190, US

(21) Appl. No.: 12/738,428

(22) PCT Filed: Dec. 21, 2007
(86) PCT No.: PCT/GB07/50782

§ 371 Date: Jul. 9, 2010

(30) Foreign Application Priority Data
Oct. 16, 2007 (GB) 0720199.9

(51) Int. Cl. H01Q 19/06; H01Q 1/12; H01Q 15/06; H01P 11/00

(52) U.S. Cl. 343/753; 343/878; 29/600

(57) ABSTRACT

A lightweight convex waveguide lens for receiving and/or transmitting electromagnetic signals to/from one and/or multiple signal sources, with the ability to send and receive signals at the same time. This is achieved by assembling wave guiding channels (waveguides) in a structured array (super structure). The waveguides can be partly pre-assembled prior to assembly in the super structure.

This invention relates to a waveguide array.

### BACKGROUND

There are many sizes and shapes of waveguide antennas and lenses for different purposes and frequencies. Such antenna devices can consist of everything from one waveguide to several put together in an assembly.

Since all waveguide antennas must be conductive a great problem is to achieve good conductivity and electromagnetic wave guiding behaviour within reasonable cost and weight.

Another problem is connected to how many waveguides are assembled together in one waveguide lens antenna unit. For example, a transformed solid block of copper, aluminium or other metals will give heavy assemblies when scaled up to larger sizes 1000 mm. There are also issues with manufacturing and manufacturing rationality connected to large waveguide assemblies.

Large waveguide lens structures can for example be created by milling waveguide channels in blocks of solid materials. Another way of producing waveguide antennas is moulding, which is fairly quick and cheap, but also connected to a need for high volume output and static designs, i.e. designs that are not based on specific customer needs or specific performance requirements.

Moulding will also limit the size of the antenna due to declining waveguide performance.

The above waveguide antennas cannot be easily repaired if milled out from solid materials. Generally antenna devices using waveguides tend to be overweight due the difficulty of optimizing material use in a completed assembly.

The rapid increase in complexity and cost for larger waveguide lens antennas (1000 mm in diameter) creates a need for lower cost manufacturing, lower weight; but which still meet required high gain specifications for both signal and structural performance.

For marine use of a lens antenna system there is a need for bigger sizes to achieve the kind of performance levels needed to both receive and transmit signals/information (TV and internet etc.).

Scaling up the waveguide lens to the double diameter dimension means that it increases over 4 times (or more) in thickness. This leads to a change of thinking when designing and manufacturing the lens. A lens with a thickness of 500 mm, using a moulding method with solid polymer waveguides, would dampen incoming and outgoing microwave signals and therefore give a poor performing antenna system. Moulding also means that a draft angle of 1-2° is needed to be able to separate the moulded part from the mould. Using long waveguides in the design and trying to apply the draft angles will affect the performance of the antenna and/or make the solution impossible by not meeting the performance specification.

The greatest obstacle is how to make the lightweight design conductive; given its function.

It is an object of the present invention to address the abovementioned disadvantages.

According to the present invention there is provided an apparatus and method as set forth in the appended claims. Other features of the invention will be apparent from the dependent claims, and the description which follows.

According to a first aspect of the invention there is provided a superstructure for a waveguide lens, wherein the superstructure comprises a plurality of waveguide holding elements, said waveguide holding elements being secured together to form the superstructure.

The waveguide holding elements may be perforated, preferably to receive waveguides in the perforations.

The waveguide holding elements may be secured to a frame, which frame may comprise interlocking frame elements. The frame elements may comprise means for locating the waveguide holding elements.

The waveguide holding elements may form a convex superstructure.

The waveguide holding elements may be ring-shaped, which ring-shapes may overlap one another.

The superstructure preferably comprises two openings for receipt of each waveguide, preferably one opening is provided on a first face and one opening is provided on a second face of the superstructure. Preferably, the faces are convex faces.

Preferably, the superstructure provides zones for waveguides, preferably the zones are ring-shaped. A non-circular central zone may be provided. The zones are preferably centred on an optical axis of the superstructure.

Preferably, the superstructure is symmetric about a plane substantially perpendicular to the optical axis.

According to another aspect of the invention there is provided a waveguide lens comprising a plurality of waveguides, a plurality of said waveguides incorporating waveguide horns on each end of a waveguide pipe thereof.

The waveguide pipes are preferably hollow. The waveguide pipes are preferably substantially square in cross-section. The waveguide pipes preferably have an electrically conducting coating on at least one of an interior or an exterior surface thereof.

The waveguides may incorporate at least one waveguide horn, preferably a waveguide horn at each end of the waveguide pipe. Said waveguide horn preferably has an electrically conducting coating on side walls thereof. Some waveguides may have no waveguide horns.

The waveguide horns preferably flare away from the ends of the waveguide pipe. Preferably, the waveguide horns flare in both directions perpendicular to the axis of the waveguide pipe. The waveguide horns may have angled or sloping ends.

The waveguide horns are preferably made of solid material, for example expanded polystyrene.

The waveguide lens is preferably a wideband waveguide lens, preferably adapted to transmit and receive over a frequency range of substantially 10.25 GHz to 14.5 GHz. Preferably, the lens has an operating range, defined by (fmax−fmin/fcentre)*100, in the range 10% to 40%, more preferably 15% to 35% more preferably 18% to 30%, where fmax is the maximum operating frequency, fmin the minimum operating frequency, fcentre the central frequency.

The waveguide lens is preferably a convex waveguide lens, preferably being convex on both sides thereof.

Preferably, the waveguides are arranged in rings centred on a central axis of the lens. The rings are preferably concentric. The waveguides may have a linear, or side-by-side, arrangement in a central section of the lens, in order to achieve closer packing of the waveguides.

Preferably, the rings of waveguides, or zones, have equal time delay in each zone.

Some of the waveguide pipes may have no waveguide horns. The lens may be greater than 1 m in diameter.

The waveguide lens may comprise a superstructure as described in the preceding aspect.

The invention extends to a waveguide lens having a superstructure of the first aspect and a plurality of waveguides.

The waveguides may be as described in the preceding aspect.

According to another aspect of the present invention there is provided a method of manufacturing a waveguide lens, said method comprising:
assembling a superstructure of the lens;
inserting a plurality of waveguide pipes into openings in the superstructure to secure the waveguide pipes in position; and
securing waveguide horns to ends of at least some of the waveguide pipes.

A cover may be placed over the waveguides secured in the superstructure.

According to another aspect of the invention there is provided a method of manufacturing a waveguide for a waveguide lens, the method comprising forming a section of pipe to length and coating at least an inner or an outer surface of the pipe with a conductive coating.

The forming of the pipe to length may be cutting the pipe to length.

The method may include securing waveguide horns to ends of the pipe.

The coating may be a plating on plastic process applied to the pipe; which may be an electroplating process, which may involve coating inner and outer surfaces of the pipe.

The coating may be a coating of the pipe and side walls of horns secured to the pipe.

The method may include removing a conductive coating from ends of the horns.

All of the features described herein may be combined with any of the above aspects, in any combination.

### DESCRIPTION

For a better understanding of the invention, and to show how embodiments of the same may be carried into effect, reference will now be made, by way of example, to the accompanying diagrammatic drawings in which:

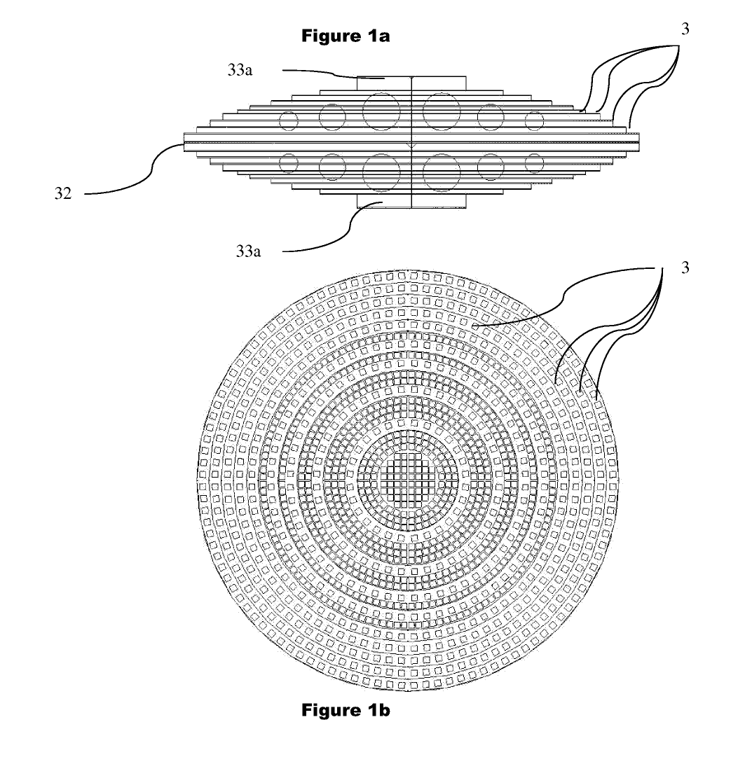

FIG. 1a is a schematic diagram of a cut-away side view of a superstructure or core structure of a waveguide lens array consisting of cross-section members, base plate and level rings;

FIG. 1b is a schematic plan view of the superstructure or core structure of FIG. 1a;

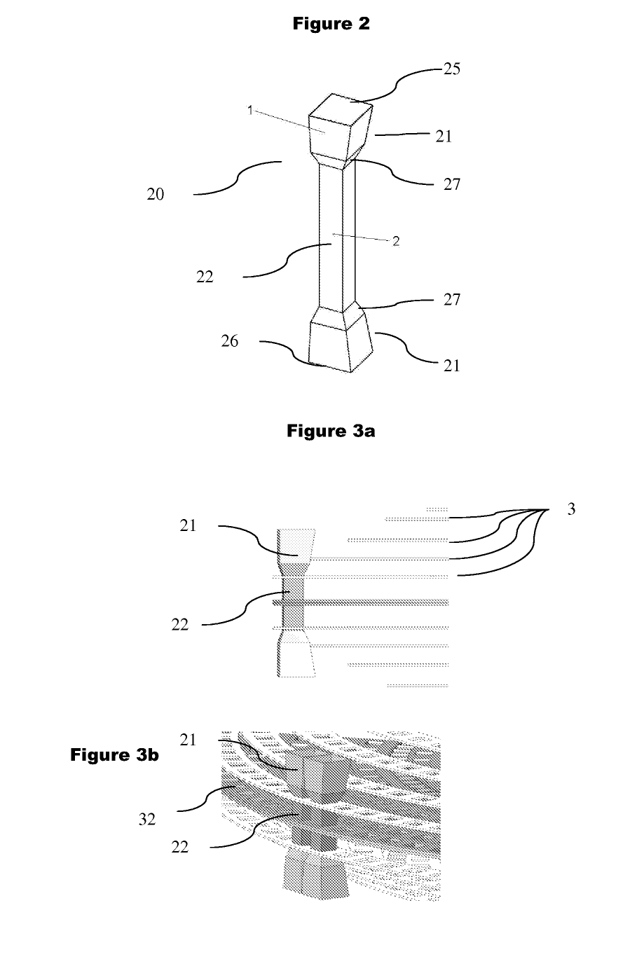

FIG. 2 is a schematic side perspective view of a waveguide unit consisting of two aperture horns and a waveguide pipe;

FIG. 3a is a partial schematic side view of the superstructure having waveguides fitted therein;

FIG. 3b is a partial schematic perspective view of the superstructure having waveguides fitted therein;

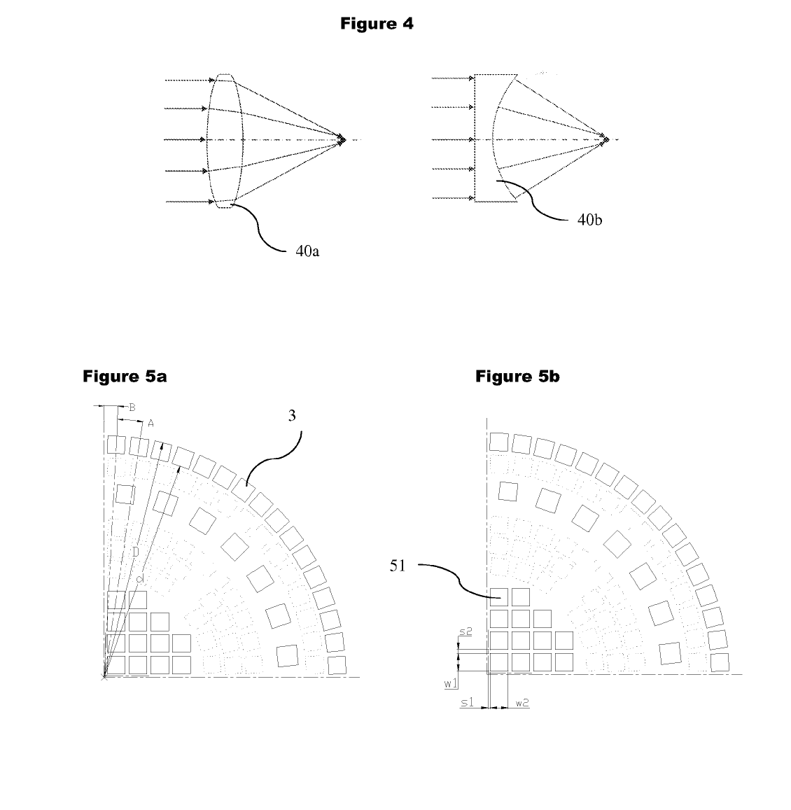

FIG. 4 is a schematic view of focussing by convex and convex/concave waveguide lenses;

FIGS. 5a and 5b show a partial section of one of the layers forming a circular array of the superstructure for supporting the waveguides;

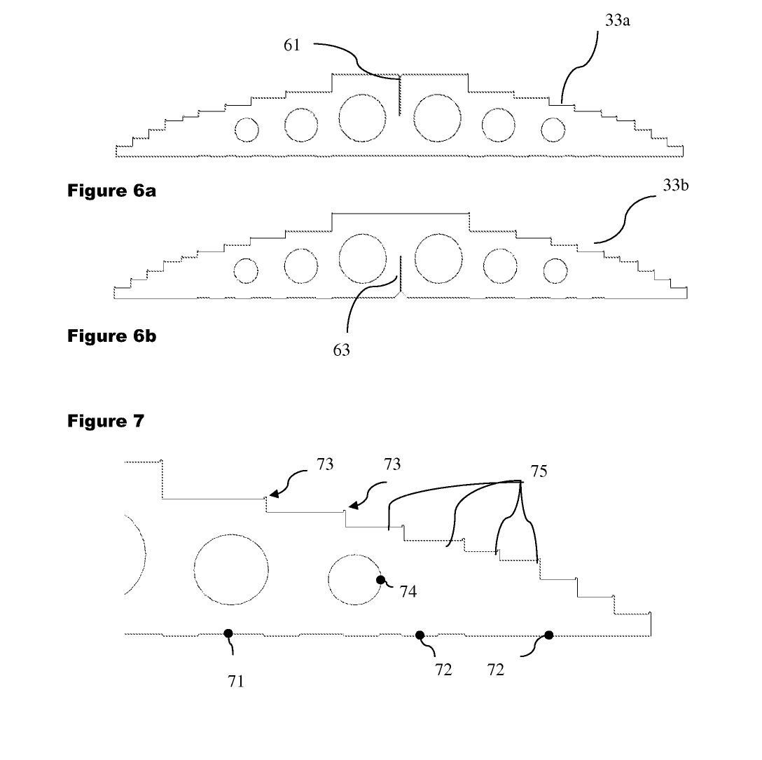

FIGS. 6a and 6b show cross-section members of the superstructure;

FIG. 7 is a schematic partial side view of one of the cross-section members;

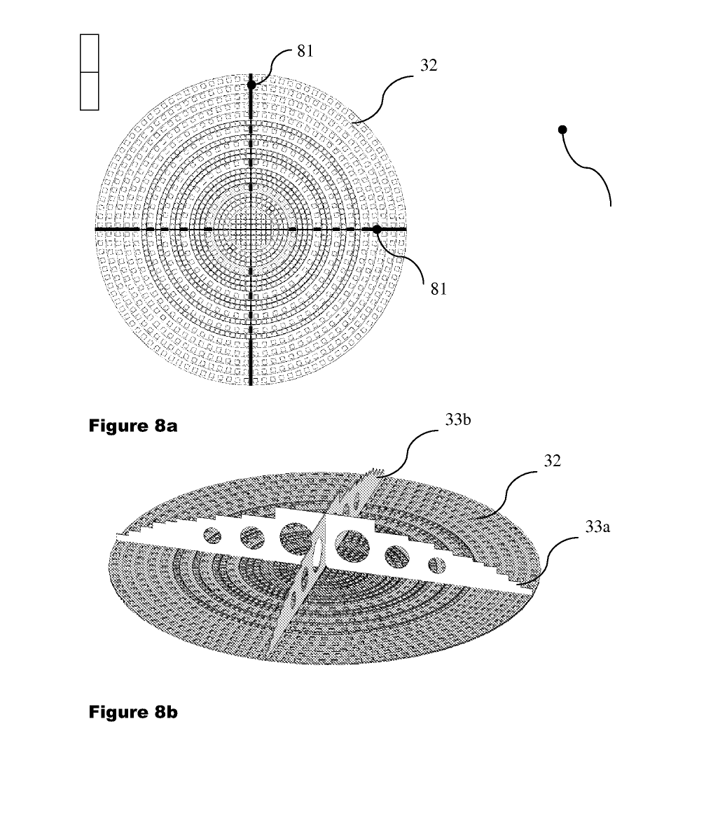

FIG. 8a is a plan view of a base plate of the superstructure;

FIG. 8b is a perspective view of the base plate with cross-section members in position;

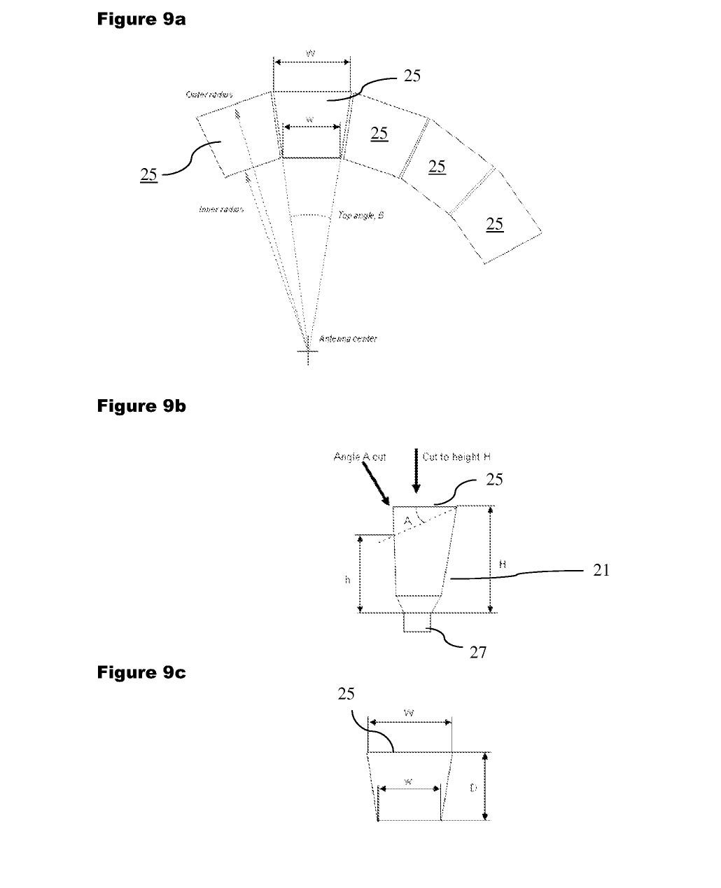

FIG. 9a is a schematic top view of top surfaces of five aperture horns to be fitted in the superstructure;

FIG. 9b is a schematic side view of an aperture horn showing how the horn is cut to a chosen angle;

FIG. 9c is a schematic view from above showing dimensions of an aperture horn;

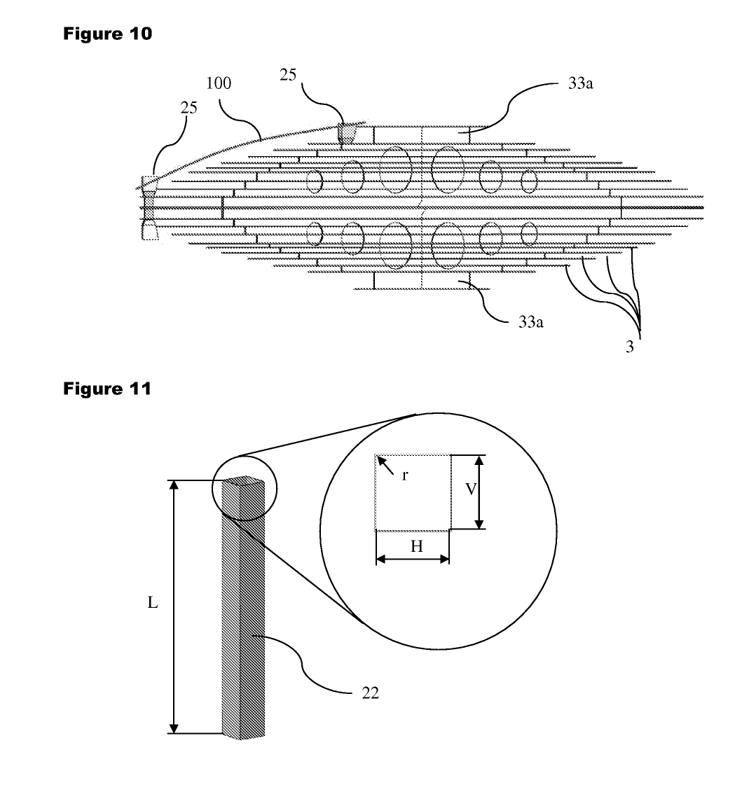

FIG. 10 is a schematic side view of the superstructure carrying two waveguides to illustrate a lens profile;

FIG. 11 illustrates important dimensions of the pipe of the waveguide;

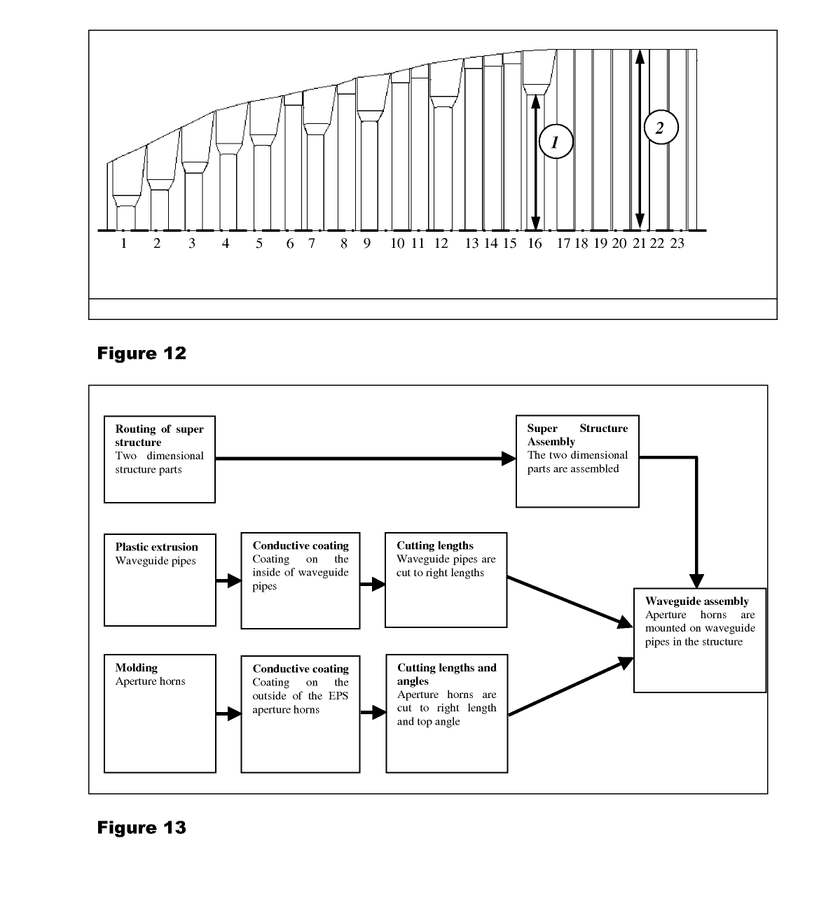

FIG. 12 is a schematic side view of an array of waveguides, some with aperture horns and some consisting solely of pipes;

FIG. 13 is a flow chart of a process for manufacturing a lens consisting of the superstructure and waveguides;

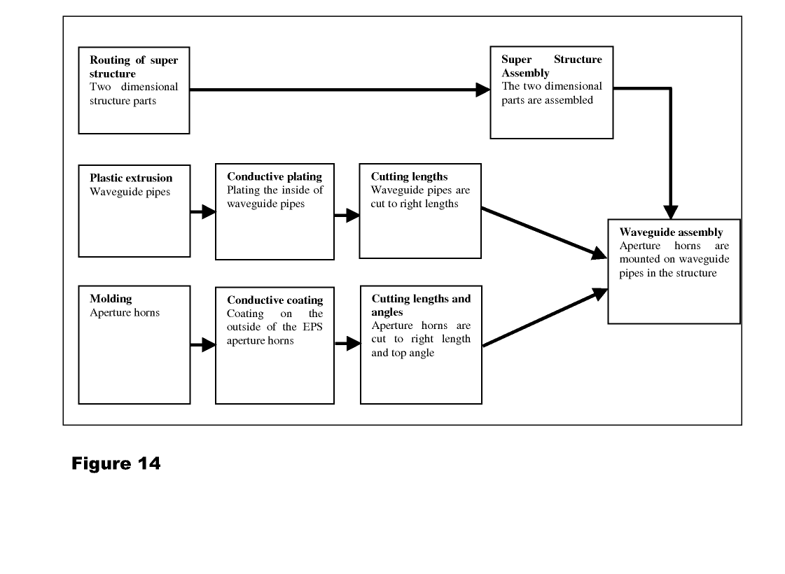

FIG. 14 is a flow chart of an alternative process for manufacturing a lens consisting of the superstructure and waveguides

When scaling up the design of a waveguide lens it has been found to be advantageous if the lens is made double-convex. This has to do with the length of the waveguides and the receiving and transmitting heads offset to avoid so called shadowing effects of electromagnetic signals.

The invention relates to the ability to cheaply and rationally manufacture lightweight waveguide channels that can be mounted in circular, quadratic or linear arrays for electromagnetic signal manipulation such as, for example, concentration. Furthermore, the invention relates to receiving and or transmitting signals from terrestrial or extraterrestrial signal sources. The waveguide channels consisting of hollow square waveguide pipes and solid aperture horns are made of different polymers and later assembled. When assembled, the waveguide pipe and aperture horns create a scalable and transformable unit.

The uniqueness of utilizing polymers for creating waveguides is the low weight and fairly uncomplicated manufacturing, and also the creation of conductive surfaces on the polymers in order to give the waveguide its physical/electromagnetic behaviour.

A waveguide channel consists of a straight or slightly bent waveguide channel produced through a common polymer extrusion process and equipped with solid polymer aperture horns. The solid polymer aperture horn 1 (see FIG. 2) is shaped in height, width and has release angles in order to optimize close packed arrangement of waveguide channels when mounted in the super structure (FIG. 1 and FIG. 3). The length, width and height of the wave guiding channel can be altered in order to adapt the waveguides length to a predetermined profile at a certain position in the superstructure's circular array.

The manufacturing process for the superstructure consists of cutting flat 2D sheets of polymer and building up a 3D super structure consisting of levels perforated by holes through which the waveguides are assembled. The waveguides are built up by assembling and mounting extruded polymer pipes having correct height and inner dimensions with the solid polymer aperture horns in the superstructure on pre-determined distances from the centre of the waveguide lens antenna.

The waveguides units can be assembled in circular, quadratic or linear arrays and form an antenna which can be used for receiving or transmitting certain electromagnetic frequencies, especially microwaves in the range of 10.25 to 14.5 GHz. These waveguides are arranged in a superstructure with cut outs for mounting purposes. The superstructure itself can for example consist of a solid block material with holes cut out and/or thin levels (exemplified in FIG. 1) with cut outs through which the waveguide channels are mounted.

The completed assembly will be given a surface cover that gives extra support to the fragile antenna parts and/or giving the assembly preventive stability against vibration and possible fractures.

### SPECIFIC EMBODIMENTS THE INVENTION

In more detail, the solution to the above problems is to design and manufacture a double convex and circular symmetrical lens antenna that consists of a superstructure (FIG. 1) and waveguide units 20 (FIG. 2) that consist of pipes 22 manufactured through polymer extrusion and horns 21 manufactured through moulding and mounted in the super structure (FIG. 3). The design is intended for lenses 1000 mm.

The waveguides 20 are mounted in the super structure, which consists of layers 3 (FIG. 1/3). The purpose of the structure is to hold the waveguides 20 in position. In this embodiment the structure consists of a base plate 32 and layers 3 made of polymer (which may be fibre reinforced) sheets which have cut outs for allowing this.

The aperture horns 21 are solid and made conductive by applying a conducting coating on the outer surface. The top and bottom part of the aperture horn is later cut off in order to remove the conductive coating from the ends and to guide electromagnetic waves through the solid material and in to the waveguide pipe 22.

The waveguide pipes 22 are hollow and made conductive with a conductive coating process on the inside or electroplated (preferred) through a POP, Plating On Plastic, process. The former gives a 20 micrometer thick metal layer or a solid film in order to not leak out electromagnetic waves to the surroundings; this is performed on the inside of the pipes. The latter process will give a thin electroplated surface cover but both on the inside and outside due to the electrolytic process; an electrolytic bath in which the waveguides will be electroplated.

The waveguide 20 is a short element with a square cross-section having conductive surfaces. By altering the length and width of the waveguide 20 the phase of the electromagnetic wave can be manipulated to go faster or slower. This idea is based on well known fundamentals of physics and states that when electromagnetic wave is guided between two conductive boundaries parallel to the electrical vector, the phase velocity of electromagnetic waves inside a waveguide is greater than in open air. The dielectric material in this embodiment is air but can be altered if needed.

The waveguide 20 as a unit can be used in waveguide lenses to create spherical or planar waves for sending and receiving electromagnetic signals. The waveguides 20 can be used to create convex 40a and/or concave 40b (FIG. 4) lightweight waveguide lenses by altering the length and square dimensions of the waveguide.

In a lens with a diameter of 1200 mm, the lens consists of twenty-three circular arrays of holes (formed by the layers 3) with different diameters and different waveguide shapes giving 23 different indexes of refraction (see FIG. 1b). Every 360 degree array of waveguides has its own refractive index due to its waveguide dimension, i.e. length and width. Therefore, the phase is shifted forward in a waveguide, and focusing is done through correct waveguide dimensions (length, width) and locations. In order to make close packed assemblies of waveguides in such arrays the aperture horns need to be modelled to fit in a circular sense and also in a radial sense side by side, but also to give an adequate side profile, depending on where it is located in the assembly.

When designing a waveguide for a certain frequency the dimensions of the through cut (quadratic) of a waveguide are calculated. The length of the waveguides 20 is varied depending on how far from the antenna center the waveguide 20 located.

### Superstructure

The super structure consisting of the base plate 32, cross-section members 33 and layers 3 forming level array rings acts as a matrix in which the waveguide units 20 are mounted and held in position. The superstructure's main function is to keep the waveguides 20 in place and keep the geometric relation between individual waveguides 20. The waveguides 20 are fixed, without any movement, in the structure. The structure can be shaped to ease the creation of convex or concave lenses by making it convex or concave. In FIG. 1a the structure is convex to create a convex waveguide lens.

The whole structure is axially perforated by holes (superstructure hole-array) for mounting waveguide channels.

The waveguides are arranged in a circular array pattern. Every 360 xdegree circular array (formed by a sheet 3) has its own diameter and in theory the spacing between each waveguide is 360 degrees divided by the amount of waveguides on the specific diameter. Every such array is numbered from the ring outermost from the centre inwards. The name for the circular array with the biggest diameter is called “Circular array 1” and the number is increased for every circular array with a smaller diameter. The number of circular arrays increases with increased antenna diameter.

In FIGS. 5a and 5b a detail of a central quarter section of one of the layers 3 is shown. Angle A gives the separation angle between squares on each array—each square takes the pipe 22 of a waveguide 20. Since the prototype antenna has been produced in quarter sections there is a need for an angle B which turns the first and last square angle out from the symmetry line. The angles for quarter sections are calculated by dividing the 90 degree sector with the number of square holes for the specific array in the quarter section.

For the central section 51 a side-by-side array of square holes is used to enable close packing of the waveguides 20. In FIG. 5b s1 shows the horizontal distance between square holes, s2 shows the vertical distance between holes, w1 gives the horizontal width of the holes and w2 gives the vertical width of the square holes.

The waveguide pipes 22 will be slotted through each of the square holes prior to the horns 21 being fitted.

The cross section members 33a and 33b shown in FIGS. 6a and 6b are mounted on the base plate 32 of the superstructure through slots (see FIG. 7) in the base plate 32. There are also slots in the two different versions of the cross section members 33a and 33b to enable them to be mounted as a cross across the base plate. Cross section member 33a has an upper slot 61 that engages with a lower slot 63 of cross section member 33b. When cross section member 33b is placed downwards onto cross section member 33a at an angle of 90 degrees thereto in a horizontal plane a cross is formed.

The cross section members 33a, 33b have two purposes, one is to hold up the array level rings 3 but also to give the whole superstructure stability. A few features were built in to cross section members 33a,b to ease the mounting of level rings and assembly with base plate, as described below.

In FIG. 7 elevated sections 71 will rest on top of the base plate 32, i.e. they will not enter slots (see FIG. 8) in the base plate 32. Projections 73 are provided on outer edges of steps 75 for easier placing of the level rings 3 on to the cross section members. In addition small grooves (not shown) are made in the level rings 3 in order to make them fit on to the cross section members 33a,b.

Holes 74 are also made in the cross-section members 33a,b to reduce weight.

In order to fit the cross section members 33a,b in the base plate 32 the base plate 32 had to be changed. Slots (or grooves) 81 were made in the base plate 32 into which the cross section members 33a,b will fit.

### Waveguide Channel

As a waveguide channel a square thin walled polymer pipe is chosen together with solid polymer aperture horns 21. Since the aperture horns 21 are going to be fitted on both ends of waveguide pipes 22 there is a need to make them light weight. There will be approximately thousands of units of the aperture horns 22 in one waveguide lens assembly, which makes it very important with a low weight solution.

The waveguide channel 22 will be an extruded polymer pipe which will be coated with a conductive coating on the inside or plated through a POP process (Plating On Plastic).

The aperture horn 21 will be moulded from a polymer and coated with a conductive coating on the outside, perhaps pre-coated with primer base colour.

### Aperture Horn

The principle of the waveguides 20 is to create solid aperture horns 21 and plug them into the waveguide pipe 22 from each side using a fit interface 27. All surfaces of the aperture horn 22 will be covered with a conductive coating which is removed from the top aperture 25 and bottom aperture 26. The top aperture 25 will also have a predetermined angle of slope and the side faces will also have adapted release angles. The fit interface 27 is the part of the aperture horn that is mounted in the waveguide pipe 22.

Since the aperture horns 21 are going to be fitted on both ends of waveguide pipes 22 there is a need to make them light weight. By utilizing the knowledge that expanded polystyrene (EPS) does not disturb electromagnetic waves in the microwave spectrum, aperture horns 21 can be created by for example using solid EPS material with a conductive coating.

The aperture horns 21 are defined by characteristic dimensions and angles (see FIGS. 9a to 9c) and are adapted to where they are located in relation to other waveguides and other aperture horns. The angle A in FIG. 9b is critical for the creation of a waveguide profile for example in a waveguide lens, because it defines the angle of refraction.

The angle A is the angle at which the aperture horn 21 is cut to give the finished upper aperture 25. H is the height of the aperture horn 21 from the fit interface 27 to the upper part of the aperture slope 25. h is the height of the aperture horn 21 from the fit interface 27 to the lower part of the aperture slope 25.

In FIG. 9a shows the measurement w, which is the minor width of the aperture slope 25 and W, which is the major width of the aperture slope 25. Also relevant is angle B, which is the angle made at the centre of the antenna by the sides of the top slope 25. Furthermore the inner and outer radius of aperture slope 25 with respect tp the antenna centre are relevant.

In FIG. 10 the outer profile of the superstructure is shown with reference to the aperture slopes 25 of two waveguides 20. The angle that the aperture slope 25 makes with respect to the base plate 32, when taken in conjunction with the other aperture slopes provides a lens profile 100.

### Waveguide Pipe

The waveguide pipes 22 are thin walled and produced through extrusion. The corner radius “r” (FIG. 11) is minimized and the lengths V and H are equal to each other. The length, L, is selected with consideration to where the waveguide 20 is being mounted in the super structure.

In some situations, as shown in FIG. 12 there is a difference in waveguide lengths if the waveguide pipe 22 has aperture horns attached to it or not.

### Manufacturing Process

The manufacturing is outlined in the process diagram FIG. 13 and FIG. 14. The differences between the two alternatives are the coating and plating processes. In FIG. 13 the conductive coating is performed for both aperture horn and waveguide pipe. In FIG. 14 the conductive coating for the waveguide pipes is changed to plating on plastic (POP) but the conductive coating process still remains for the aperture horn.

The provision of a superstructure provides significant manufacturing advantages. Also the two methods of coating the waveguide pipes and horns allow the manufacture in a simple manner, of lightweight waveguides.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A superstructure for a waveguide lens, wherein the superstructure comprises a plurality of waveguide holding elements, said waveguide holding elements being secured together to form the superstructure.

2. A superstructure as claimed in claim 1, in which the waveguide holding elements are perforated to receive waveguides in the perforations.

3. A superstructure as claimed in claim 1, in which the waveguide holding elements are secured to a frame,

4. A superstructure as claimed in claim 3, in which the frame comprises interlocking frame elements.

5. A superstructure as claimed in claim 1, in which the waveguide holding elements form a convex superstructure.

6. A superstructure as claimed in claim 1, in which the waveguide holding elements are ring-shaped.

7. A superstructure as claimed in claim 1, which superstructure comprises two openings, each for receipt of a waveguide.

8. A superstructure as claimed in claim 1, which superstructure has a plurality of zones for waveguides.

9. A superstructure as claimed in claim 8, in which at least one of the plurality of zones has a non-circular central zone.

10. A superstructure as claimed in claim 8, in which the plurality of zones are centered on an optical axis of the superstructure.

11. A superstructure as claimed in claim 1, in which the superstructure has an optical axis and is symmetric about a plane substantially perpendicular to the optical axis.

12. A waveguide lens comprising a plurality of waveguides, wherein at least one of said plurality of waveguides has a waveguide pipe with a pair ends and waveguide horns on each end of the waveguide pipe.

13. A waveguide lens as claimed in claim 12, in which the waveguide pipes are hollow.

14. A waveguide lens as claimed in claim 12, in which the waveguide pipes are substantially square in cross-section.

15. A waveguide lens as claimed in claim 12, in which the waveguide pipes have an electrically conducting coating on at least one of an interior or an exterior surface thereof.

16. A waveguide lens as claimed in claim 12, in which the waveguide horns have an electrically conducting coating on side walls thereof.

17. A waveguide lens as claimed in claim 12, in which the waveguide horns flare away from the ends of the waveguide pipe.

18. A waveguide lens as claimed in claim 12, in which the waveguide horns are made of solid material.

19. A waveguide lens as claimed in claim 12, which is a wideband waveguide lens.

20. A waveguide lens as claimed in claim 12, which is a convex waveguide lens.

21. A waveguide lens as claimed in claim 12, in which the waveguides are arranged in rings centered on a central axis of the lens.

22. (canceled)

23. A method of manufacturing a waveguide lens, said method comprising:
assembling a superstructure of the lens;
inserting a plurality of waveguide pipes into openings in the superstructure to secure the waveguide pipes in position; and
securing waveguide horns to ends of at least some of the waveguide pipes.

24. The method of claim 23, in which a cover is placed over the waveguides secured in the superstructure.

25. A method of manufacturing a waveguide for a waveguide lens comprises forming a section of pipe to length and coating at least an inner or an outer surface of the pipe with a conductive coating.

26. The method of claim 25, which includes securing waveguide horns to ends of the pipe.
